(19) United States
(12) Patent Application Publication
(10) Pub. No.: US 2009/0060165 A1
(43) Pub. Date: Mar. 5, 2009

(54) Method and System for Customer Transaction Request Routing

(76) Inventors: Pradeep Kumar Dani, Suwanee, GA (US); Raymond Gerber, Duluth, GA (US)

Correspondence Address: PHILIP H. BURRUS, IV, 460 Grant Street, Atlanta, GA, 30312, US

(21) Appl. No.: 11/856,817

(22) Filed: Sep. 18, 2007

Related U.S. Application Data
(60) Provisional application No. 60/969,121, filed on Aug. 30, 2007.

(51) Int. Cl. H04M 3/00

(52) U.S. Cl. 379/265.13

(57) ABSTRACT

A system (100) and method (900) for routing customer transaction requests, such as electronic installment loan applications (101) is provided. The routing facilitates efficient workflow between a plurality of customer service centers (103, 104, 105) by generating a number within a predetermined range and associating it with the incoming customer transaction request. Each customer service center (103, 104, 105) has associated therewith a subset range of the predetermined range. A queue item builder (110) builds a queue item by querying a database (109) to determine to which customer service center (103, 104, 105) the customer transaction request is to be sent based upon the number and the subset ranges associated with each customer service center (103, 104, 105). A routing module (111) then directs the customer transaction request to the proper customer service center (103, 104, 105).

### CROSS REFERENCE TO PRIOR APPLICATIONS

This application claims priority and benefit under 35 U.S.C. § 119(e) from U.S. Provisional Application No. 60/969,121, filed Aug. 30, 2007.

### BACKGROUND

1. Technical Field

This invention relates generally to method and system for routing customer transaction requests received over a network, and more specifically to a method and system for directing customer transaction requests, such as electronic loan applications, to one of a plurality of customer service centers.

2. Background Art

The increasing popularity of the Internet and the World Wide Web has led to an increase of on-line services. By way of example, before Internet commerce one needed to visit a bank or other financial institution to obtain a loan. Now, however, one may apply for installment loans, lines of credit, and even home mortgages on-line.

While the process of obtaining a loan may be completed on-line, lenders still must perform due diligence analyses on prospective borrowers. For instance, prior to loaning a prospective borrower money, the lender may wish to verify the borrower's name, age, occupation, employer, credit history, and so forth. Sometimes, the on-line process makes this due diligence more difficult because the lender is unable to meet the prospective borrower face to face.

Lenders have put into place some electronic means to perform the due diligence analysis. Additionally, some on-line lending systems provide prospective borrowers with electronic means to provide verification of certain financial data. A prospective borrower may be able to provide a bank account number and a routing number from a check, for instance. The lender may then electronically verify that the account exists. When this electronic verification fails, however, perhaps when a prospective borrower makes a typographical error when entering the account, some lenders elect to direct the electronic loan application to a customer support center to have a customer support representative call the prospective borrower. A problem with this method exists in that customer support centers have limited resources. There are only so many customer support representatives to handle the incoming application load. This problem traverses industry lines, in that any business offering customer service from an on-line transaction may face the same issue.

There is thus a need for a system and method for managing incoming customer transaction requests.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a system for routing customer transaction requests in accordance with the invention.

FIG. 2 illustrates one screen shot from an automated loan offering system from which customer transaction requests may be routed in accordance with embodiments of the invention.

FIG. 3 illustrates one screen shot from an automated loan offering system from which customer transaction requests may be routed in accordance with embodiments of the invention.

FIG. 4 illustrates one screen shot from an automated loan offering system from which customer transaction requests may be routed in accordance with embodiments of the invention.

FIG. 5 illustrates one screen shot from an automated loan offering system from which customer transaction requests may be routed in accordance with embodiments of the invention.

FIG. 6 illustrates one screen shot from an automated loan offering system from which customer transaction requests may be routed in accordance with embodiments of the invention.

FIG. 7 illustrates one embodiment of a process flow for routing customer transaction requests in accordance with methods and systems of the invention.

FIG. 8 illustrates an exemplary set of queues to which customer transaction requests may be routed in accordance with the invention.

FIG. 9 illustrates one method for routing customer transaction requests received across an electronic network in accordance with embodiments of the invention.

FIG. 10 illustrates one embodiment of a method for routing customer transaction requests within a customer service center in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to routing customer transaction requests, such as partially completed on-line loan applications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of customer transaction request routing as described herein. As such, these functions may be interpreted as steps of a method. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention present methods and systems for routing customer transaction requests through customer service centers. “Customer transaction requests” refers to at least a portion of a business transaction that occurs across a network with the assistance of computers, having processors and memory storage devices, running executable code. Customer transaction requests include, but are not limited to, applications for credit, orders for goods, orders for services, customer service requests, survey responses, and the like. For the purposes of discussion, an on-line installment loan system will be used herein as an illustrative application for the methods and systems of the invention. It will be clear to one of ordinary skill in the art having the benefit of this disclosure, however, that the invention is not so limited. Other systems, including business-to-consumer electronic commerce systems, business-to-business electronic commerce systems, and so forth.

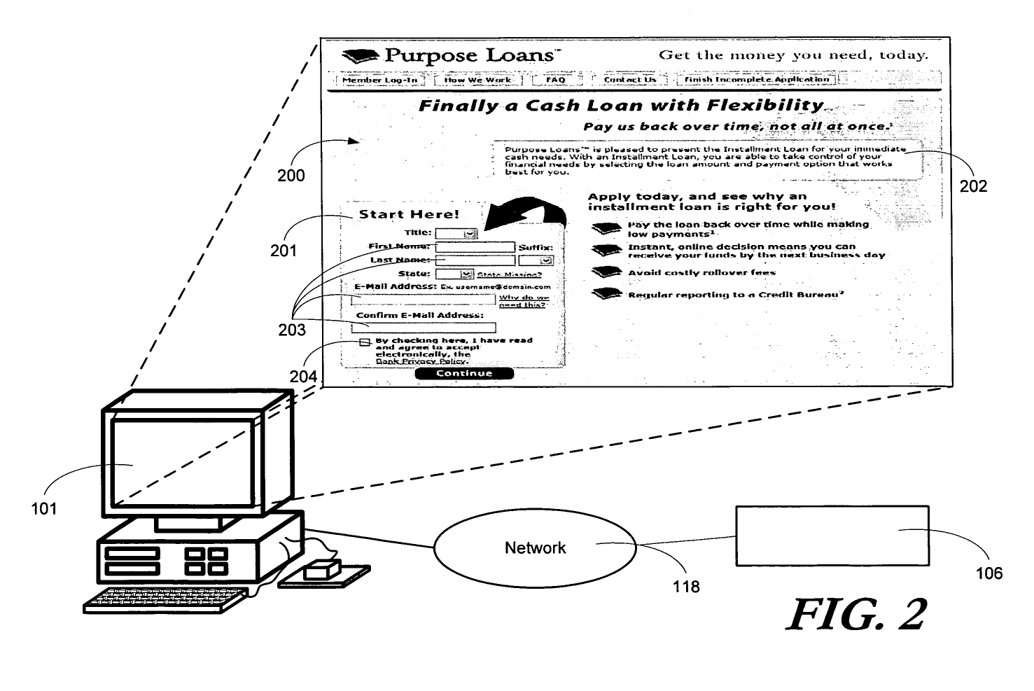

In the illustrative embodiment, a prospective borrower applies for an on-line installment loan through a web portal operating on a computer. FIGS. 2-6 below illustrate one exemplary application system. The lender, as noted above, requires certain verifications of financial and personal information prior to transferring funds. These verifications sometimes include interaction between the prospective borrower and a customer service representative working for the lender. As such, systems and methods described herein are useful in managing incoming requests for customer service representative/prospective borrower interaction.

By way of example, the lender's on-line installment loan program may be configured to detect when the prospective borrower fails to select a loan that has been offered, or when he fails to transmit an electronic acceptance back to the lender's on-line lending system. There are many situations where a failure to receive the electronic signal indicating acceptance of a loan offer may occur. In one situation, the prospective borrower may not be satisfied with the terms associated with any of the loan offers. In another situation, the prospective borrower may need additional time to make the decision of whether to accept any of the loan offers.

In either situation, or in other situations not mentioned above, the lender operating the on-line lending system may desire to contact the prospective borrower to follow-up on the loan offer. For example, the lender may want to ensure that no technical glitch has occurred. Further, the lender may want to discuss other lending options with the prospective borrower. The lender may further want to address any reservations the prospective borrower may have with the loan offers presented. To address these issues, embodiments of the present invention provide a system for a customer service representative to execute the follow-up communication.

Customer service representatives work at customer service centers. Many businesses today use multiple customer service centers. Each center may have a different number of customer representatives working therein. As such, each center may be capable of accommodating different numbers of customer transaction requests. Additionally, the centers may be spread around the world. Some may work at different times than do others. Embodiments of the present invention provide queuing systems to facilitate proper delivery of customer service requests to each center.

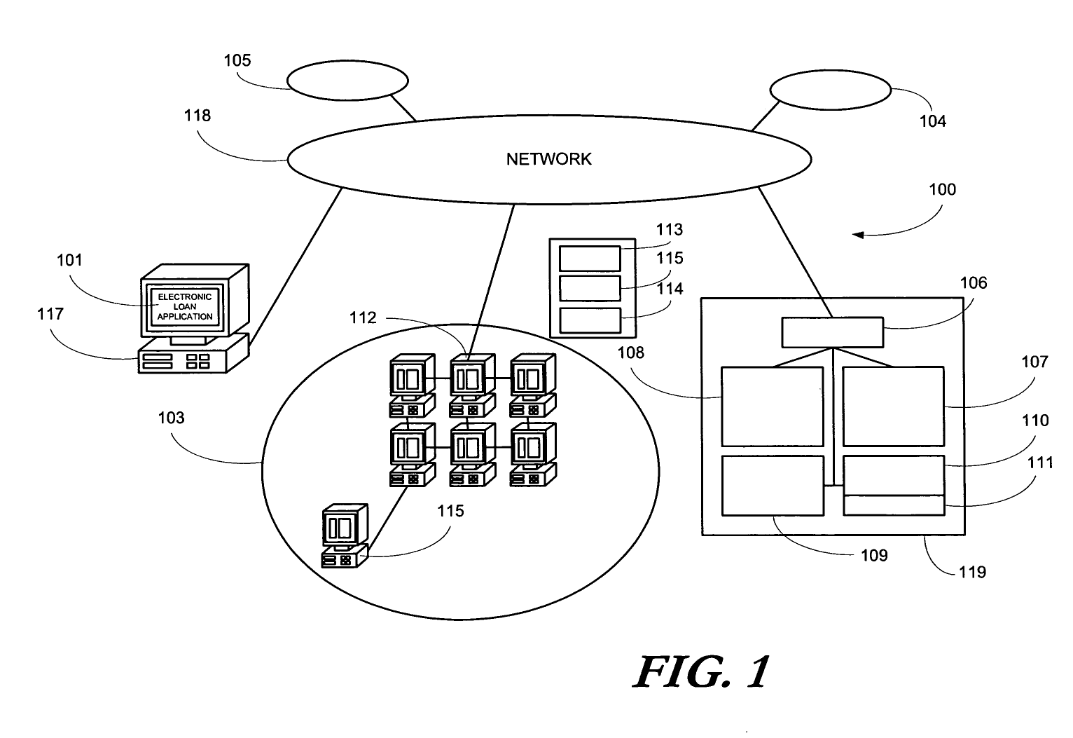

Turning now to FIG. 1, illustrated therein is one system 100 for use in routing customer transaction requests received over an electronic network 118 in accordance with embodiments of the invention. The central components of the system are the customer service center 103 and the central server 119. A customer initiates contact with the system 100 through a web portal 117, which may be a web browser operating on a client computer. Referring to the exemplary application, a user may complete an electronic loan application 101 and transmit it across the network 118 to the server 119. This electronic loan application 101 works as the customer transaction request in such an application.

The server 119 includes an electronic interface 106 that is configured to receive customer transaction requests. In the exemplary application, the electronic interface 106 receives the electronic loan application 101 from the network 118.

The server 119 includes an analyzer 107 that is configured to determine whether customer assistance with the customer transaction request is required. The analyzer 107, which in one embodiment is a software module stored in memory on the server 119 and operative on a processor of the server 119, scans the customer transaction request for issues that are indicative of the need for customer assistance. For instance, the analyzer 107 may check to see if the electronic loan application 101 is complete. Next, the analyzer 107 may check to see if the electronic loan application 101 has been signed. The analyzer 107 may check to see if the accompanying documents requested during the electronic loan application process have been attached. Where the analyzer 107 detects that customer service is required, the customer transaction request is so flagged. In some embodiments, all customer transaction requests will be flagged as requiring customer assistance when the analyzer 107 is in a default mode.

Customer transaction requests requiring customer service representative assistance must be managed so that customer service centers 103,104,105 are not overloaded. In one embodiment, this management is facilitated by a number flag, which may be random, sequential, or selected from another algorithm. Specifically, a number generator 108 is configured to generate a number within a predetermined range, and to assign that number to each of the customer transaction requests requiring customer service representative attention. By way of example, a random number between 1 and 100 may be selected and assigned to a customer transaction request. Alternatively, the number generator 108 may select numbers sequentially between 1 and 100. A first customer transaction request may be assigned 1, a second 2, and so forth. Other algorithms may also be used.

Once the number generator 108 has selected a number and assigned it to a corresponding customer transaction request, a queue item builder 110 is configured to associate the customer transaction requests with one of a plurality of customer service centers 103, 104, 105 based upon the number assigned by the number generator 108. This occurs, in one embodiment, as follows: A database 109 has stored therein numerical identifiers—each constituting a sub-range of the predetermined range—associated with the plurality of customer service centers 103, 104, 105. The first customer service center 103 may be assigned a range of 1 to 20, a second customer service center 104 may be assigned a range of 21 to 80, a third customer service center may be assigned a range of 81 to 100, and so forth. The queue item builder is configured to associate the customer transaction requests based on both the number assigned by the number generator 108 and the sub-ranges associated with the customer service centers 103, 104, 105. Where, for example, the number generator 108 assigns the number “41” to a customer transaction request, the queue item builder 110 would then associate that customer transaction request with the second customer service center 104 because 41 falls within its sub-range of 21 to 80. Once associated, the queue item builder 110, in one embodiment, is configured to write the queue item built to the database 109 as a field associated with an assigned customer transaction request.

Once the queue item builder 110 has done this, a routing module 111—responsive to the queue item builder 110—is configured to direct each customer transaction request to the appropriate customer service center across the network 118. Within each customer service center exist additional queues, as will be discussed momentarily.

As an illustrative example, suppose a customer completes an electronic loan application 101 and transmits it to the server 119 across the network 118. The electronic interface 106 then receives the electronic loan application 101 and delivers it to the analyzer 107. The lender operating the server 119 wants each prospective borrower to be contacted by a customer service representative to ensure “the personal touch,” so the analyzer 107 is in default mode and flags the electronic loan application 101 as needing customer service representative attention. The number generator 108 then, by whichever algorithm, assigns the electronic loan application 101 the number 12. The queue item builder 110 then queries the database 109 and determines that the first customer service center 103 is associated with the number 12. The routing module 111 then delivers the electronic loan application 101 to the first customer service center 103.

Upon receipt at the first customer service center 103, a queuing module 113, which may be a software module running on a processor in a customer service center terminal 112, is configured to receive customer transaction requests from the routing module 111. The received customer transaction requests will be only a subset of all customer transaction requests in that there are multiple customer service centers 103, 104, 105, each having its own queuing module.

Note that the customer service center 103 may include a plurality of customer service center cells, with each cell comprising one or more customer service representative terminals 120. Where this is the case, the customer service center terminal 112 will direct received customer transaction requests to one of the customer service center cells. This can be done by way of the number. For instance, if once customer service cell serves a sub-range from 80-92, and a customer transaction request is received by the customer service center terminal 112 having the number 83 associated therewith, the customer service center terminal 112 may routed—perhaps through the queuing modules—to that customer service center cell.

The queuing module 113 may be further configured to assign received customer transaction requests to an incoming customer service center queue modules 114. For instance, in the illustrative application, when a prospective borrower selects an offered on-line loan, but fails to electrically sign the application, the queuing module 113 may be configured to direct that customer transaction request to a pending offer queue, which is one of the customer service center queue modules 114. Where the prospective borrower selects an offered on-line loan and signs electronically, the queuing module 113 may be configured to deliver that customer transaction request to a pending verification queue.

In one embodiment, a notification module 115 in the customer service center terminal 112 is configured to direct customer transaction requests to at least one customer service representative terminal 120. This may be accomplished by presenting a notification prompt on the customer service representative terminal 120 requesting that the customer service representative pull the customer transaction request from the customer service center terminal 112. Alternatively, the customer service center terminal 112 may automatically push the customer transaction request to the customer service center terminal 120. When either occurs, the queuing module is configured to advance the customer transaction request to a verification in process queue, which is indicative of the fact that a customer service representative has opened and is working on the customer transaction request.

The advantages of the random/sequential/other number routing are many. To begin, it is very simple for a purveyor of the system 100 to remove a customer service center 103, 104, 105 if necessary. For example, if one call center is having technical difficulties, that call center can be removed by simply changing the associated sub-ranges in the database 109.

Next, call center capacity may be modified by changing the sub-range associated with that call center. If a call center formerly capable of handling 20% capacity is not capable of handling 30% capacity, that call center's sub-range may simply be adjusted, for example, from 1 to 20 to 1 to 30.

As noted above, in one embodiment, the system 100 is an on-line installment loan offering system. As such, customer transaction requests comprise electronic loan applications 101. Turning now to FIG. 2, illustrated therein is one embodiment of the electronic loan application 101 from which customer transactions may be routed in accordance with the invention. As noted above, a customer request is an on-line transaction that requires a follow-up activity prior to completion. One suitable application for systems and methods in accordance with embodiments of the invention is that of an on-line installment loan process. FIGS. 2-6 illustrate screen shots associated with one such on-line installment loan. It will be obvious to those of ordinary skill in the art having the benefit of this disclosure that other applications will be equally well suited to embodiments of the invention, including on-line sales systems, on-line customer service systems, on-line search systems, and so forth.

Turning first to FIG. 2, illustrated therein is one embodiment of an electronic loan application 101 presented on a client browser portal. A lender employing a system in accordance with the invention may provide prospective borrowers with access to the electronic loan application 101 over a network 118, such as the Internet. The prospective borrower uses the client browser portal, which in one embodiment is an Internet browser, to access the electronic loan application 101.

The illustrative embodiment shown in FIG. 2 is that of an electronic loan application 101 comprising a start page 200. In one embodiment, the prospective borrower is first presented with the start page 200 upon accessing the electronic interface 106. The start page 200 may comprise a start pane 201 into which identification information is entered. Additionally, the start page 200 may also include company information 202 introducing the prospective borrower to the on-line lending company. The prospective borrower may need to provide at least one piece of personal identification information 203 before continuing to the actual on-line loan application. This personal identification information 203, in one embodiment, is transferred as a first portion of the customer transaction request to the electronic interface 106. The personal identification information 203 may include, but is not limited to, a name, an email address, or a user identification name.

The prospective borrower may be required to read and agree to a lender privacy policy 204. This may occur after the personal identification information 203 is entered, but before more of the electronic loan application 101 is presented. Once the prospective borrower has both indicated that the lender privacy policy 204 has been read and has entered the personal identification information 203, the personal identification information 203 and the acceptance of the lender privacy policy 204 are then transmitted to the electronic interface 106 over the network 118.

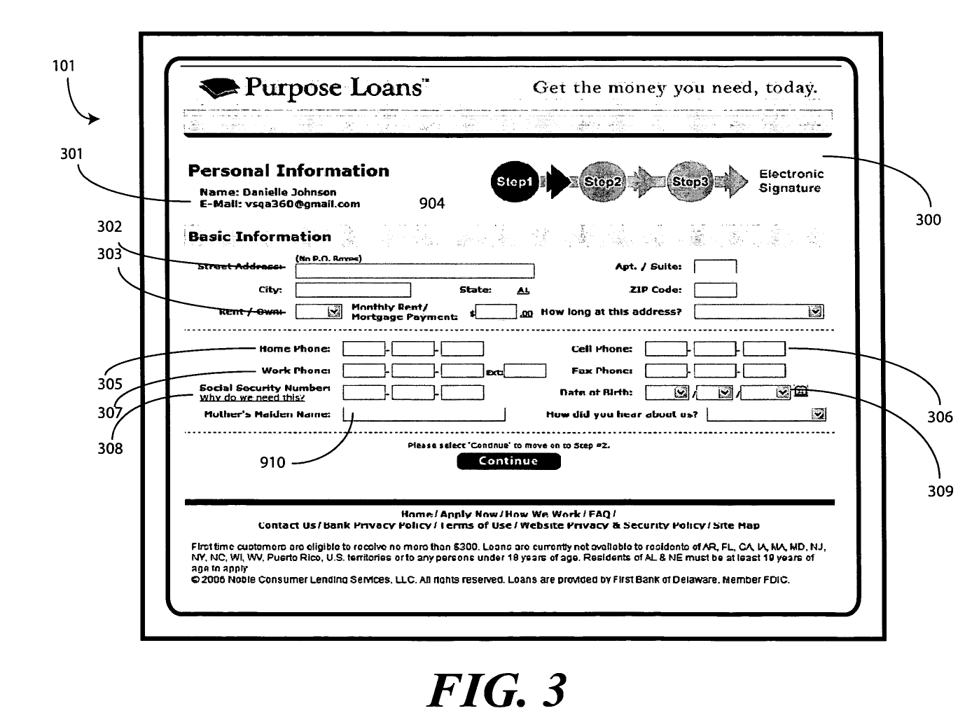

Turning now to FIG. 3, illustrated therein is a second screenshot associated with embodiments of the invention from which customer transactions may be routed. As shown in FIG. 3, the exemplary electronic loan application 101 includes a personal information request page 300 with which a prospective borrower is queried for additional personal information 301. The personal information request page 300 may be presented to the prospective borrower following the transmission of the personal identification information (203). In one embodiment, the requested personal information 301 includes the prospective borrower's home address 302, residential status (owner or renter) 303, amount of housing payments (mortgage or rent) 304, home telephone number 305, cell phone number 306, work phone number 307, social security number 308, date of birth 309, and mother's maiden name 310. The personal information 301 entered by the prospective borrower is then transmitted to the electronic interface (106).

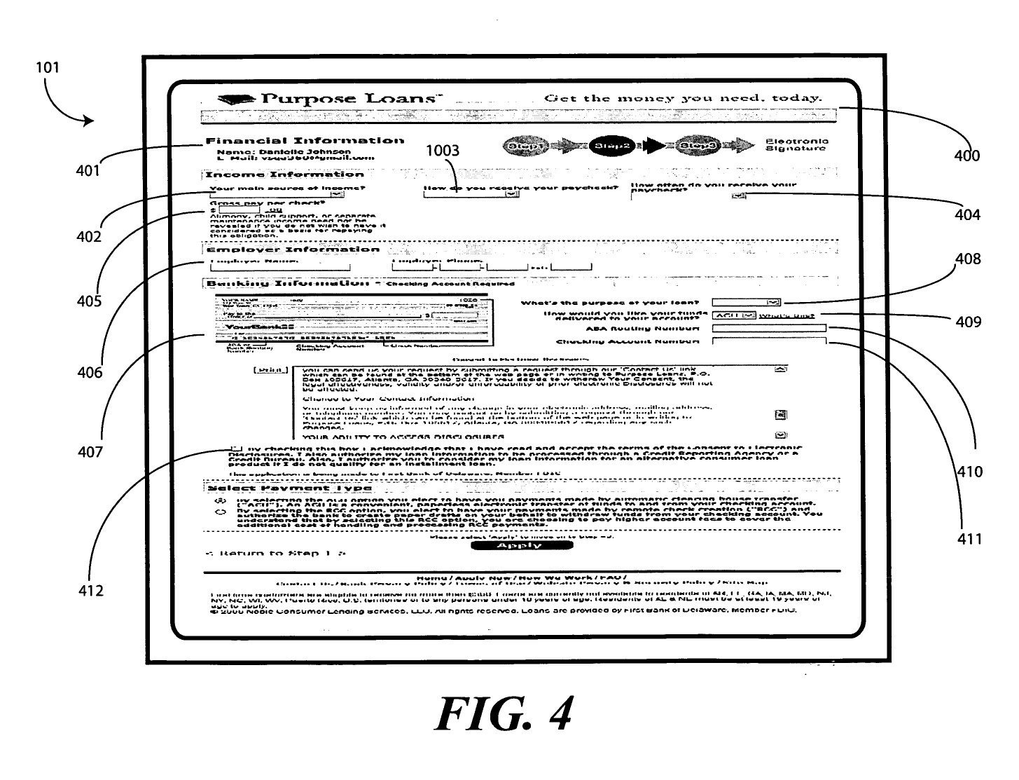

Turning to FIG. 4, illustrated therein is one embodiment of the electronic loan application 101 from which customer transaction requests may be routed. The screen shot of FIG. 4 includes a financial information request page 400 with which the prospective borrower is queried for financial information 401. The financial information request page 400 may be presented to the prospective borrower following submission of the personal information (301). In one embodiment, the financial information 401 is used by the system to determine whether to approve the prospective borrower, as well as whether to present a loan offer to the prospective borrower. The requested financial information 401 may include, but is not limited to, the prospective borrower's source of income 402, method of receiving paychecks 403, frequency of receiving paychecks 404, amount of paychecks 405, and employer information 406.

In one embodiment, the financial information 401 includes banking information 407. Providing banking information 407 may help expedite repayment of the loan through the electronic transfer of funds from a checking account. Additionally, electronic transfer of funds may reduce the overall cost of the loan to the prospective borrower. In one embodiment an Automatic Clearing House (ACH) is used to facilitate the repaying of the loan offer. Requested banking information may include: a purpose for the loan 408, a method for electronic transfer of funds 409, such as ACH or remote check creation, an American Banking Association (ABA) routing number 410, a checking account number 411, and an acknowledgement of having read terms and conditions 412 corresponding to consent of electronic disclosure.

The financial information 401 is then sent over the network (118) to the electronic interface (106). The system then works with the database (109) to store the data. The system then operates on the data, making decisions as to whether to offer the prospective borrower the loan.

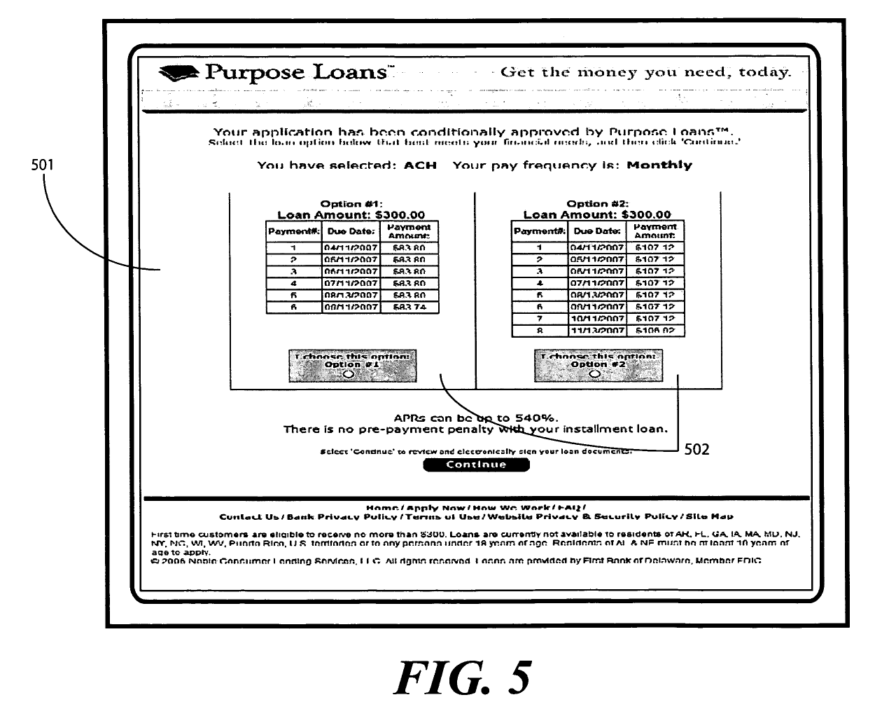

Turning to FIG. 5, illustrated therein is one embodiment of the one or more loan offers 501 presented, via the Network (118), to the user. Acceptance of either of these loan offers 501 forms the main subject of the customer transaction request in an on-line lending application. In the illustrative embodiment of FIG. 5, two different loan offers 502 are presented. While two loan offers 502 are shown, one, three, or four or more loan offers could equally be shown. Multiple loan offers may be presented when the prospective borrower has optional payment schedules. Additionally, multiple loan offers may be presented when the prospective borrower qualifies for differing loan amounts.

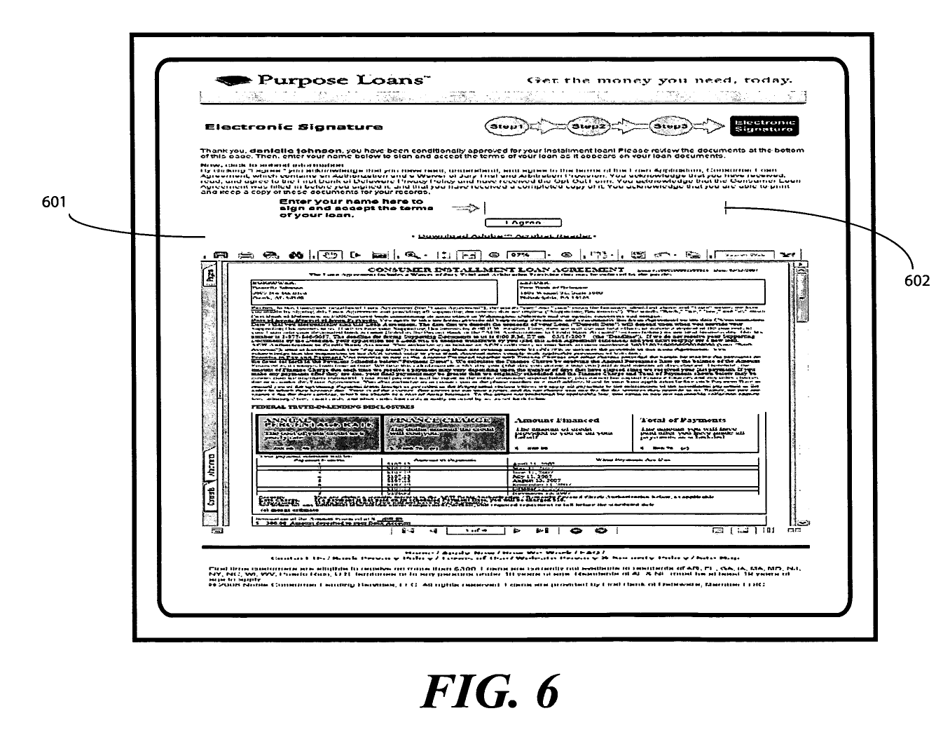

Turning now to FIG. 6, illustrated therein is one embodiment of an optional terms and conditions agreement 601 presented to the customer prior to completion of the customer transfer request. In one embodiment, a terms and conditions agreement 601 may be presented along with the one or more loan offers (502). The terms and conditions agreement 601 may, among other things, inform the prospective borrower about their fiscal responsibility upon accepting a loan offer. Such fiscal responsibility may include knowledge of annual percentage rates, finance charges, total amount financed, and amount of monthly payments. Privacy information and other processing information may additionally be presented.

In one embodiment, the terms and conditions agreement 601 includes a request 602 for the terms and conditions agreement 601 to be executed. Execution of the terms and conditions agreement 601 may be required before any one loan can be completed. Where the customer fails to execute the terms and conditions agreement 601, the customer transaction request comprises a partially completed on-line loan application. Such a partially completed loan application, where the terms and conditions agreement 601 is required, would necessitate customer service assistance.

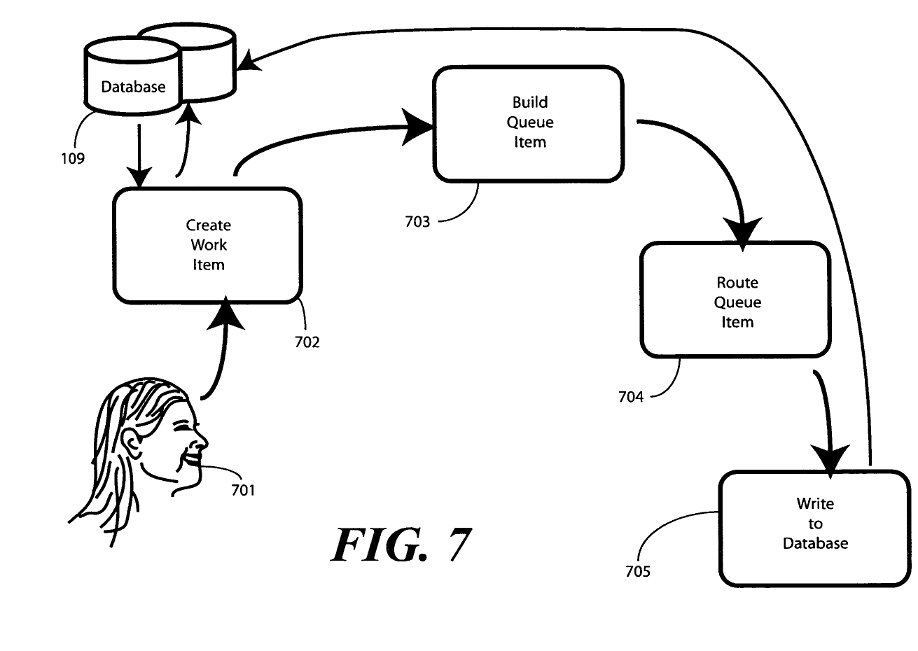

Turning now to FIG. 7, illustrated therein is a flow diagram of one embodiment of a set of actions that may occur in the server (119) upon receipt of an electronic loan application (101) as a customer transaction request. Once a customer transaction request is received by the electronic interface (106), a work item is created at block 702. This work item may be created automatically, for example in conjunction with the analyzer (107), or may alternatively be created with the assistance of a call center agent 701. Once the number has been assigned by the number generator (108), the queue item builder 110 queries the database 109 to get identification subranges associated with a particular call center based upon sub-range mapping in the database 109. The queue item builder 110 then builds the queue item at block 703. Additional information may be placed in the queue item, including any information needed to identify the account, the customer transaction request, or the call center.

The routing module (111) then routes the queue item in accordance with the number and the corresponding sub-range call center identification at block 704. The routing module (111) may make the routing decision based upon a properties set defined in the queue item. At block 705, the queue item is written to the database 109.

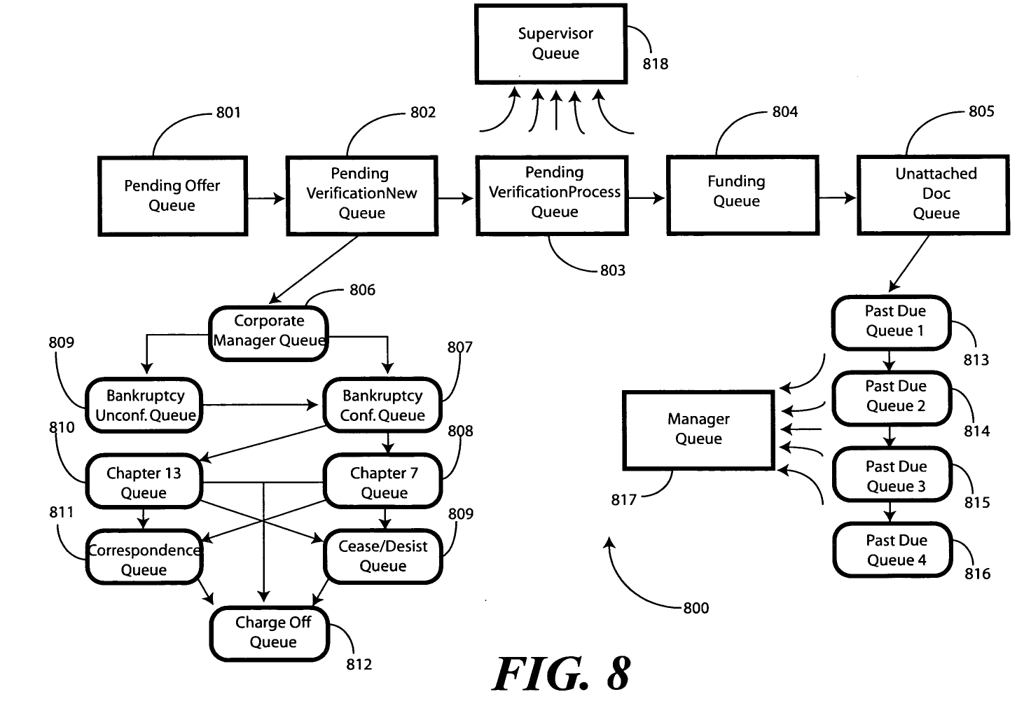

Turning now to FIG. 8, illustrated therein are several exemplary queues that may be included as queue modules (114) in the customer service center terminal (112). In the exemplary application, when a customer transaction request reaches the customer service center terminal (112) it is routed into either the pending offer queue 801 or the pending verification queue 802. Customer transaction requests—which are on-line installment loan applications in the exemplary application—that are not electrically signed are directed to the pending offer queue 801, while signed applications are routed to the pending verification queue 802.

Other side-queues may exist as well. For instance, where a prospective borrower is in a certain state, such a bankruptcy, there may be a special set of queues with which to perform due diligence. Using bankruptcy as an example, if a bankruptcy flag is detected, the customer transaction request may be directed to a manager queue 806 for further due diligence. If the bankruptcy is unconfirmed, the customer transaction request is moved to a bankruptcy unconfirmed queue 809 until verification can be established. Once bankruptcy is verified, the customer transaction request moves to the bankruptcy confirmed queue 807. Depending upon the type of bankruptcy, both a chapter 13 queue 810 and a chapter 7 queue 808 exist. If the prospective borrower needs additional correspondence, a correspondence queue 811 exists. If the lender is prohibited under state regulations from contacting the prospective borrower, a cease and desist queue 809 exists. If a customer has had prior loans charged down, a charge off queue 812 exists. It will be clear to one of ordinary skill in the art having the benefit of this disclosure that other types of queues, both layered and sequential, may be used in accordance with embodiments of the invention depending upon application.

Once a customer service representative has opened the customer transaction request and has begun work on it, it moves to the pending verification in process queue 803. In one embodiment, a timer is in place to ensure that a customer service representative opens the customer transaction request within a predetermined period of time. Where this does not occur, the customer transaction request may be optionally moved to a supervisor queue 818 for priority attention.

Once the due diligence steps are complete and the on-line loan application has been approved, the customer transaction request moves to the funding queue 804. Funds are generally transferred to the borrower's account once a day as an electronic fund transfer. Once funding is complete, the customer transaction request moves to a completion queue 805.

The lender will then collect payments as agreed by the borrower in the on-line application process. This collection generally occurs by an Automated Clearing House (ACH) electronic funds transfer. Where the collection process is unsuccessful, such as when the borrower has insufficient funds in the account to make the collection payment, the customer transaction request will move to a first past due queue 813. As each successive collection attempt is unsuccessful, the customer transaction request will move to subsequent past due queues 814, 815, 816. At any time, depending upon account status, the customer transaction request may be moved to a manager queue 817. Such escalation may occur, for example, where a customer service representative or collection agent has questions regarding account handling.

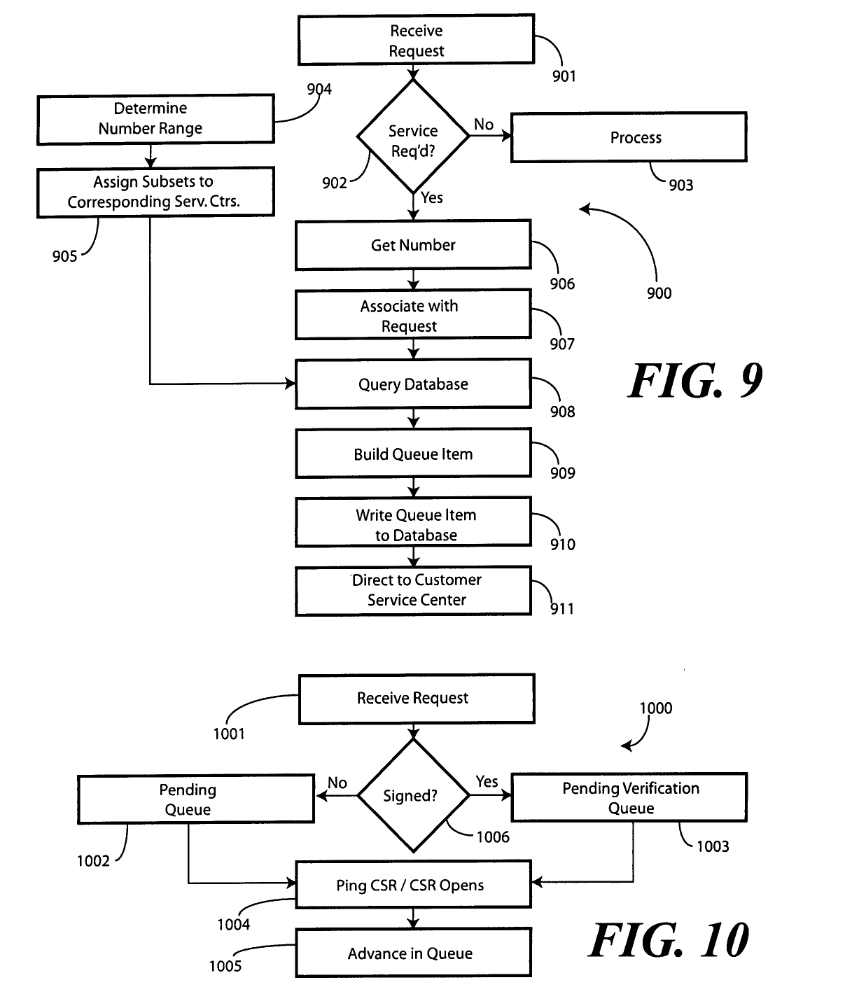

Turning now to FIG. 9, illustrated therein is one method 900 for routing customer transaction requests received from an electronic network in accordance with embodiments of the invention. The method 900 is suitable for coding as executable code for operation on the server (119) as described with respect to FIG. 1. The method 900 ensures that customer transaction requests are routed efficiently to a particular customer service center selected from a plurality of customer service centers.

At step 901, a customer transaction request is received from the network. As noted above, one such customer transaction request is an on-line installment loan application completed by a prospective borrower through a web portal. At decision 902, the method 900 determines whether service is required. In a default mode, all customer transaction requests may require customer service. In another embodiment, only some may require customer service in accordance with predetermined criteria. Where no service is required, the customer transaction request is simply processed at step 903.

Where service is required, a number within a predetermined range is generated at step 906. This number, in one embodiment, is a random number within the predetermined range. In an alternate embodiment, this number is one of a series of sequential numbers within the predetermined range. Once the number is generated, the number is associated with the customer transaction request at step 907.

In parallel, subsets of the predetermined range are associated with customer service centers at steps 904 and 905. At step 904, subset ranges are determined. These subset ranges may correspond to customer service center capacity, customer service center capabilities, and so forth. Each of these subset ranges are assigned to customer service centers at step 905. A first subset of the predetermined range may be associated to a first customer service center, for example, while a second subset of the predetermined range may be associated with a second customer service center, and so forth.

The database is queries at step 908. When querying the database, the method 900 determines the sub-ranges associated with each customer service center. In other words, the step 908 of querying determines a customer service center identification associated with one of the service centers. The queue item is then built at step 909. Building the queue item includes associating the customer service request with a customer service center based upon the number generated at step 906. The queue item may also include a queue routing item which serves as an identifier of the service center to which the customer transaction request will be routed. The queue item is then written to the database at step 910.

At step 911, the customer transaction request is directed to one of the customer service centers based upon the queue item. As noted above, the queue item is built, in part, from the number of step 906 and the sub-ranges of numbers associated with customer service centers in steps 904, 905. Thus, if the number is 11, and the first customer service center has a sub-range of 1 to 15, the customer transaction request is routed to the first customer service center.

Turning now to FIG. 10, illustrated therein is one method 1000 of directing customer transaction requests to queues within a customer service center. Such a method 1000 facilitates direction of customer transaction requests to one of the pending offer queue or the pending verification queue upon the customer transaction request being delivered to one of the customer service centers, i.e., the first customer service center, second customer service center, and so forth.

At step 1001, the customer service center receives the customer transaction request. At decision 1006, in the illustrative application, the method 1000 determines whether the prospective borrower has electronically signed the application. Where there is an electronic signature, the customer transaction request is directed to the pending verification queue at step 1003. Where there is no signature, the customer transaction request is directed to the pending queue at step 1002. Once in these queues, the method 1000, in one embodiment, electronically generates a prompt on a customer service representative terminal alerting the customer service representative to take action on the customer transaction request at step 1004. At step 1005, once the customer service representative has taken action on the customer transaction request, the customer transaction request is moved to the verification in process queue at step 1005.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method of routing customer transaction requests received over an electronic network to a customer service center selected from a plurality of customer service centers, the method comprising the steps of:
receiving a customer transaction request over the electronic network from a client portal;
determining whether customer service assistance with the customer transaction request is required;
generating a number within a predetermined range;
associating the number with the customer transaction request;
associating at least a first subset of the predetermined range with a first customer service center, and associating at least a second subset of the predetermined range with a second customer service center; and
directing the customer transaction request to the first customer service center or the second customer service center based upon then number, the first subset and the second subset.

2. The method of claim 1, wherein the customer transaction request comprises an on-line installment loan request.

3. The method of claim 1, further comprising the step of querying a database to determine a customer service center identification associated with one of the at least a first customer service center or the at least a second service center and associating the customer service center identification with the customer transaction request.

4. The method of claim 1, further comprising the step of building a queue routing item and associating the queue routing item with the customer transaction request.

5. The method of claim 4, further comprising the step of writing the queue item to a database as a customer transaction request associated field.

6. The method of claim 1, wherein each of the first customer service center and the second customer service center each comprise a plurality of customer service center cells, further comprising the step of directing the customer transaction request to one of the plurality of customer service center cells based upon the number.

7. The method of claim 1, wherein the customer transaction request comprises an on-line installment loan request, further comprising the step of directing the customer transaction request to one of a pending offer queue or a pending verification queue upon directing the customer transaction request to the first customer service center or the second customer service center.

8. The method of claim 7, further comprising the step of electronically generating a prompt on a customer service representative terminal upon directing the customer transaction request to one of the pending offer queue or the pending verification queue.

9. The method of claim 8, further comprising the step of directing the customer transaction request to a customer service center terminal and moving the customer transaction request to a verification in process queue.

10. A system for use in routing customer transaction requests received over an electronic network to a customer service center selected from a plurality of customer service centers, the system comprising:
an electronic interface configured to receive the customer transaction requests;
an analyzer configured to determine whether customer assistance is required;
a number generator configured to assign numbers within a predetermined range to each of the customer transaction requests;
a database configured to store identifiers associated with the plurality of customer service centers, wherein each of the plurality of customer service centers is associated with a predetermined sub-range of the predetermined range;
a queue item builder configured to associate each of the customer transaction requests with one of the plurality of customer service centers using the numbers as a routing crierion; and
a routing module, responsive to the queue item builder, configured to direct each of the customer transaction requests to an appropriate customer service center.

11. The system of claim 10, wherein the queue item builder is further configured to write a queue item generated by the queue item builder to the database as a field associated with an assigned customer transaction request.

12. The system of claim 10, further comprising a customer service center terminal configured to receive at least some of the customer transaction requests from the routing module.

13. The system of claim 12, wherein the customer service center terminal further comprises a queuing module, configured to assign received customer transaction requests to an incoming customer service center queue.

14. The system of claim 13, wherein the incoming customer service center queue is one of a pending offer queue or a pending verification queue.

15. The system of claim 14, further comprising a notification module configured to direct received customer transactions to at least one customer service representative terminal.

16. The system of claim 15, wherein the queuing module is further configured to advance the received customer transaction requests to a verification in process queue upon directing the received customer transaction requests to the at least one customer service representative terminal.

17. The system of claim 10, wherein the numbers comprise random numbers.

18. The system of claim 10, wherein the numbers comprise sequential numbers.

19. The system of claim 10, wherein the system comprises an on-line installment loan offering system.
